(19) United States
(12) Patent Application Publication
(10) Pub. No.: US 2003/0164571 A1
(43) Pub. Date: Sep. 4, 2003

(54) Inert gas curing process for in-mold coating

(76) Inventors: L. Scott Crump, Gladstone, MO (US); Shoujie Li, Overland Park, KS (US)

Correspondence Address: WHYTE HIRSCHBOECK DUDEK S C, 111 EAST WISCONSIN AVENUE, SUITE 2100, MILWAUKEE, WI, 53202

(21) Appl. No.: 10/349,349

(22) Filed: Jan. 22, 2003

Related U.S. Application Data
(60) Provisional application No. 60/319,091, filed on Jan. 22, 2002.

(51) Int. Cl. B29C 39/12

(52) U.S. Cl. 264/85; 264/259; 264/265

(57) ABSTRACT

A process is disclosed to eliminate or diminish oxygen inhibition of the curing of coating resins in the composite industry. A free radical curable coating is applied to a mold surface and an inert gas is used to protect the coatings from oxygen in the air during the cure. The inert gases can be, but are not limited to, nitrogen gas and carbon dioxide gas. The inert gas or mold or both can be heated to a temperature above room temperature.

### CROSS REFERENCE TO RELATED APPLICATION

This application claims the benefit under 35 USC §119(e) of U.S. Provisional Application No. 60/319,091 filed Jan. 22, 2002.

### BACKGROUND OF THE INVENTION

This invention is related to the art of in-mold coating processes in the composite industry. In particular, this invention focuses on a method of minimizing oxygen inhibition of free radical polymerization during the curing of coatings.

Oxygen inhibits free radical polymerization. Significant efforts have been made to understand the oxygen inhibition mechanism and the effect of the inhibition on free radical polymerization. Some samples of such literature are as follows: L. Goldgarb, C. Foltz, and D. Messersmith, J. of Polymer Science: Polymer Chemistry Edition, (1972), Vol. 10, pp. 3289-3294. H. Maybod and H. George, Polymer Letters Edition, (1977), vol. 15 pp. 693-698. D. Bolon and K. Webb, J. of Applied Polymer Science, (1978), Vol. 22, pp. 2543-2551. M. George and A. Ghosh, J. of Polymer Science: Polymer Chemistry Edition, (1978), Vol. 16, pp. 981-995. G. Plews and R. Phillip, J. of Coating Technology, (1979), Vol. 51, No. 648, pp. 69-77. G. Odian, Principles of Polymerization, McGraw-Hill, (1981), pp. 249. C. Decker, J. of Coating Technology, (1987), No. 751, pp. 59-65. The dramatic inhibition effect of oxygen in the air is one of the most difficult problems to solve in the composite field because of the great affinity of oxygen toward free radicals. In addition, the reactions with oxygen result in air-cured coatings containing oxygenated structures, such as hydroperoxides and peroxide groups, that have deleterious effects on the performance of the cured coatings. Moreover, oxygen inhibition has a particularly strong detrimental effect on coatings because coatings have a large surface area in contact with the oxygen in the air and they also have a thin depth through which oxygen can penetrate. The susceptibility of coatings to oxygen inhibition leads to many problems, for example, the coating surface stays tacky, or even wet, for extended periods of time thereby prolonging the production cycle. Oxygen inhibition of coatings can also adversely affect the coating's performance, resulting in inferior characteristics, such as low mechanical properties, poor chemical and water resistance, and poor weathering because of the oxygenated structure and low molecular weight.

There are several known methods available to minimize the effect of oxygen inhibition on the cured coatings. One method is adding insoluble semicrystalline wax in coating formulations. After the coating is applied, the low surface tension wax particles preferentially migrate to the coating surface to prevent oxygen from contacting with the coating surface. This layer of wax leads to low gloss surface. In the case of in-mold coatings such as gel coats the presence of wax can lead to secondary bonding problems with a laminate resulting in adhesion problems.

Another approach is adding a modified resin, such as polyallyl glycidyl ether resin, which reacts with oxygen to create more free radicals. However, during polymerization, a toxic chemical compound may be released as a by-product of the reaction. Additionally, the presence of the ether groups found in the polyallyl glycidyl ether resin can result in poor water resistance.

Another approach is using ultraviolet light (UV) or an electron beam (EB) to cure coatings. High intensity radiation sources are used to generate very large numbers of free radicals at a rapid rate at the surface, so that the oxygen in the air at the coating surface is depleted and polymerization can proceed. This method is very effective for clear coatings. This method is sensitive to the thickness of coatings, colors, and filler content, and the geometry of the object to be coated should be simple so that uniform illumination is possible.

Recently, reduction or elimination of styrene or methyl methacrylate monomers (both on the list of EPA's Hazardous Air Pollution Substances (HAPS)), in in-mold coatings, such as gel coats, is required because their emission into the air is a health concern. When styrene or methyl methacrylate is replaced, partially or completely, with other monomers, such as acrylate monomers with di-, tri-, tetra-, or penta-acrylates and methylacrylates, the effect of oxygen inhibition becomes even more detrimental to the coatings. The coating remains wet for a long time after spraying. The first two methods described above have limited success in this case. Based on the information above, it is desirable to develop a process to minimize or eliminate the problem of oxygen inhibition during cure of in-mold coatings that contain acrylate monomers and have no or a small amount of styrene and methyl methacrylate.

### BRIEF SUMMARY OF THE INVENTION

The invention is a process in which a coating is applied to a surface wherein an inert gas is used to protect the coating from oxygen in the air during the cure of the coating.

In one preferred embodiment, the invention is an in-mold coating process comprising the steps of: (a) providing a mold having at least one surface adapted to form a molded part; (b) applying a curable coating to the surface of the mold, wherein the coating comprises a resin curable by a free-radical reaction and the free-radical curing reaction is inhibited by the presence of oxygen; (c) contacting the applied curable coating with a gas inert to the coating thereby displacing or diluting atmospheric air in contact with the coating such that the oxygen content in the gas in contact with the applied coating is less than the oxygen content in air; and (d) curing the coating while the coating remains in contact with the inert gas.

In another preferred embodiment, the inventive process further comprises the step of: (e) positioning a mold cover in close proximity to or in contact with the mold to substantially enclose the coated surface thereby creating a contained space between the mold and the mold cover, wherein step (e) occurs prior to or concurrently with step (c).

In still another preferred embodiment, the inventive process further comprises the step of: (f) heating the inert gas or mold or both to a temperature greater than room temperature, wherein step (f) occurs prior to or concurrently with step (d).

Hallmarks of the present invention is a process in which coatings have faster cure times, improved mechanical and chemical properties and better weatherability than the same coatings cured in an air atmosphere while reducing emission of hazardous air pollutant substances (HAPS).

### BRIEF DESCRIPTION OF THE DRAWINGS

Preferred embodiments of the invention are described below with reference to the following accompanying drawings, which are for illustrative purposes only. Throughout the following views, reference numerals will be used in the drawings, and the same reference numerals will be used throughout the several views and in the description to indicate same or like parts.

FIG. 1 is a schematic diagram of a preferred embodiment of the inventive method wherein the mold is heated by means of heating pipes.

FIG. 2 is a schematic diagram of a preferred embodiment of the inventive method wherein the inert gas is heated.

FIG. 3 is a schematic diagram of a preferred embodiment of the inventive method wherein the mold is heated by means of a heating cloth.

FIG. 4 is a schematic diagram of a preferred embodiment of the inventive method wherein the mold is heated by means of a hot liquid bath.

### DETAILED DESCRIPTION OF THE INVENTION

In the following detailed description, references are made to the accompanying drawings which form a part hereof, and in which is shown by way of illustration specific embodiments in which the invention may be practiced. These embodiments are described in sufficient detail to enable those skilled in the art to practice the invention, and it is to be understood that other embodiments may be utilized and that equivalent structural, chemical and procedural changes may be made without departing from the spirit and scope of the present invention.

The present invention provides an in-mold coating process in which coatings, such as gel coats, can be applied and cured on hard surfaces, such as mold surfaces. Oxygen in the air significantly inhibits free radial polymerization during the cure of certain types of coatings resulting in an undesirably long tacky time and the reduction of the coating performance characteristics such as mechanical properties, chemical and water resistance, and weathering. The term “tacky time” is defined as the time from application of the coating to the mold surface to the time that no material transfers to fingers when touching the coating surface with light pressure. A hallmark of this invention is decreasing or eliminating the oxygen inhibition of the coating resulting from the presence of oxygen in air. In this invention, an inert gas is employed to prevent the coating from contacting oxygen in the air. This invention significantly reduces tacky time, particularly when the styrene monomer in a coating formulation is replaced partially or completely with other monomers such as acrlyate and methylacrylate monomers with di-, tri-, tetra-, and penta-functions. In addition, we have observed an enhancement in the water resistance of gel coated laminates prepared by the disclosed process.

While the inventive method could be used with any type of air inhibited coatings, advantageously, this method is used in connection with a coating comprising a free radical curable coatings in which the free radical curing reaction is inhibited by the presence of oxygen. “Inhibited” here means that the polymerization of coatings is suppressed either completely or partially such that the tacky time of such a coating is at least about 200% longer when the coating is cured in the presence of atmospheric air compared to when the same coating is cured under a inert gas, such as nitrogen, inert to the coating and free radicals.

The inert gas usable for this invention can be any gas, or combination of gases, which will not react with the components of the coating or with the free radicals. The inert gases preferably are non-reactive atmospheric gases, such as, nitrogen, carbon dioxide and the noble gases (helium, neon, argon), preferably nitrogen. Other gases, such as non-reactive organic gases, may be used but require containment to avoid excessive emissions to the environment. The inert gas need not be pure and mixtures of inert gases are within the scope of the invention. Although not preferable, minor amounts of oxygen may still be present in the inert gas, up to a maximum amount of 5 weight percent (wt %) based on the total gas. Typically, the inert gas will be 95% to 99.999% pure. The inert gas is conveniently supplied by either a gas generator or as compressed gas from cylinders or tanks.

The inert gas is directed into contact with the surface of the coating in the mold, thereby displacing or diluting the atmospheric air previously in contact with the coating surface. In preferred embodiments, the mold is covered with a mold cover to contain the inert gas. The mold cover is placed in close proximity to the mold. Preferably, the mold cover should cover all of the coated mold surface and provide means for sealing the mold cover to the mold. The seals are preferably heat resistant up to a temperature of at least 100° C. Typically, and preferably, the seals make a gas-tight contact with the mold by silicon rubber. The seals, mold and mold cover preferably combine to form a contained space over the coated surface of the mold. Inlets and outlets in the mold cover or seals allow the inert gas to enter the contained space and the displaced atmospheric air to leave the contained space. Circulation of the inert gas through the inlet and contained space flushes the air out of the contained space and through the outlets. Preferably, the flush results in an oxygen content of the gas within the contained space of no more than 10%, more preferably less than 5%, and most preferably about 3 wt %, based on the weight of the total gas in the contained space. In at least some preferred embodiments, the inert gas will be recirculated through the contained space during the cure.

The inert gas increases the pressure in the contained space slightly, typically no more than about 1 to 20% above atmospheric pressure. The higher pressure within the contained space assures that any leakage through the mold cover or seals will be outward and therefore helps prevent atmospheric oxygen from infiltrating into the contained space.

The gap between the mold and the mold cover determines the volume of the contained space. The distance across the gap between the mold cover and the surface of the mold can vary from about 2 mm to about 100 mm or more. The gap distance is not critical to the function of the inventive method and can be chosen on the basis of convenience or for practical considerations. For example, a narrow gap minimizes the amount of gas required to fill and flush the contained space but will require careful alignment with the coated mold to avoid disturbing the coating while placing the mold cover in position. Also, for embodiments where the gas is heated, a narrow gap may not provide a large enough volume of gas to act as an effective heat source and/or complicate even distribution of the heated gas.

In certain preferred embodiments either the mold or the inert gas, or both, are heated prior to and/or during the curing step in order to accelerate the rate of curing. The mold or gas is heated above room temperature up to a temperature of about 100° C., and more desired temperature is 40-70° C.

The following four embodiments illustrate different approaches that can used to implement this inventive process. One skilled in the art will recognize that these are not the only approaches that are within the scope of this invention and that features of one embodiment may be incorporated into another embodiment.

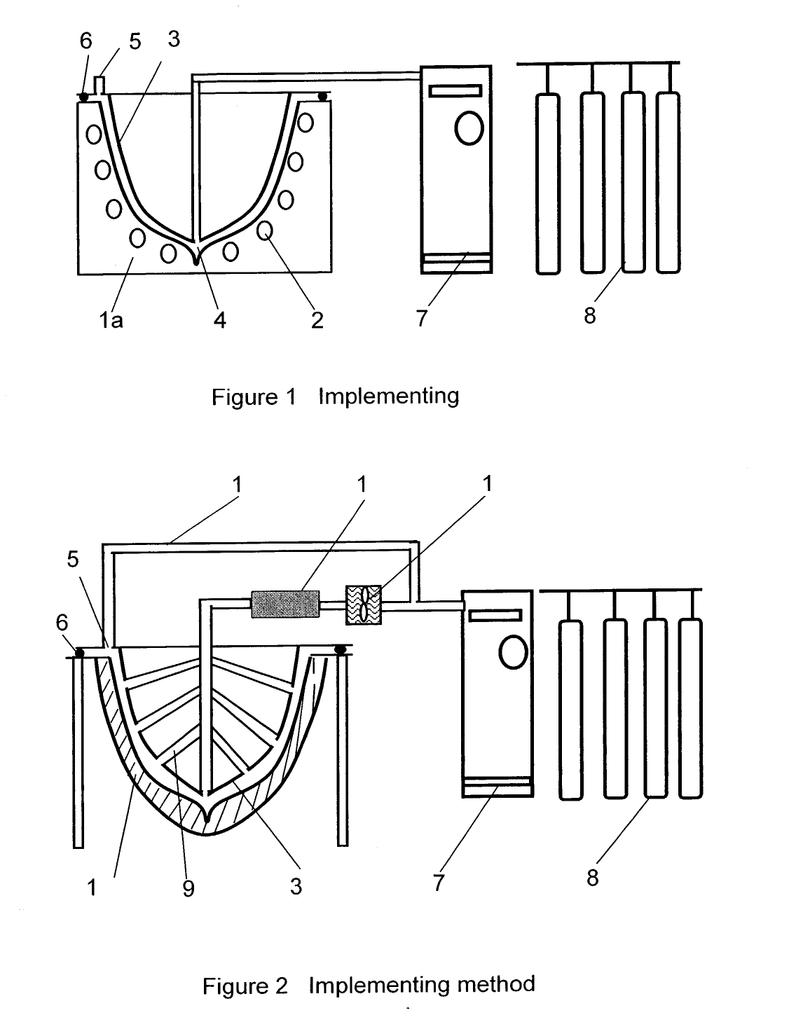

FIG. 1 shows a schematic diagram of a first preferred embodiment of this process. In this approach, a liquid coating is applied on the surface of a mold 1, which is heated from room temperature to a temperature of 70° C. (158° F.) by means of heating pipes 2 filled with a hot fluid such as hot water. The mold 1 shown here is the cross-section of a boat mold. After the coating is applied on the surface of the mold, a mold cover 3 with inlets 4 and outlets 5 covers the entire mold surface. There is a seal 6 between the mold and the mold cover along the perimeter of the mold. The gap between the mold cover 3 and the surface of the mold 1 can vary from 2 mm to 100 mm or above. An inert gas such as, but not limited to, nitrogen gas, flows through inlet 4 into the space between the mold surface 1 and the mold cover 3 to displace the air through outlets 5. The purity of the inert gas in the gap is preferably at least about 90%, more preferably at least about 95%, most preferably at least about 97%. The pressure in the gap is a little larger than the atmospheric pressure by 1 to 20%. The inert gas is supplied by either a gas generator 7 or compressed gas cylinders 8 with a purity of 95% to 99.999%. After a certain time, from 5 min to 2 hours, the mold cover 3 is removed, and the coating surface is ready to laminate. For example, glass fibers and a liquid resin can be applied onto the coating surface to make a boat.

FIG. 2 shows the schematic diagram of a second preferred embodiment of this process. In this approach, a liquid coating is applied onto the surface of a mold 1. The mold 1 shown here is the cross-section of the boat mold. After the coating is applied on the surface of the mold, a mold cover 3 with inlets 4 and the outlets 5 covers the entire mold surface. There is a seal 6 between the mold I and the mold cover 3 along the perimeter of mold 3. The gap between the mold cover 3 and the surface of mold I can vary from 2 mm to 100 mm or above. A heated inert gas heated from room temperature to 70° C. (158° F.) flows into the gap between the surface of the mold 1 and the cover 3 by the proper designed inert gas distribution pipes 9 to displace the air in the gap. Gas distribution pipes 9 should deliver the heated gas to all parts of the mold system. After the air is displaced, the heated inert gas can be circulated by a pipe 10 and a circulation fan 11. The inert gas can be heated by, but not limited to, an electric heater 12. The purity of inert gas in the gap varies from 90% to 99.999%. The pressure in the gap is a little larger than the atmospheric pressure by 1 to 20%. The inert gas is supplied by either a gas generator 7 or compressed gas cylinders 8 with a purity of 95% to 99.999%. After a certain time, from 5 min to 2 hours, the mold cover 3 is removed, and the coating surface is ready to laminate. For example, glass fibers and a liquid resin can be applied onto the coating surface to make a composite boat. The advantage of this approach is that no mold heater is needed and the uniform temperature can be achieved by a proper design of inert gas distribution system.

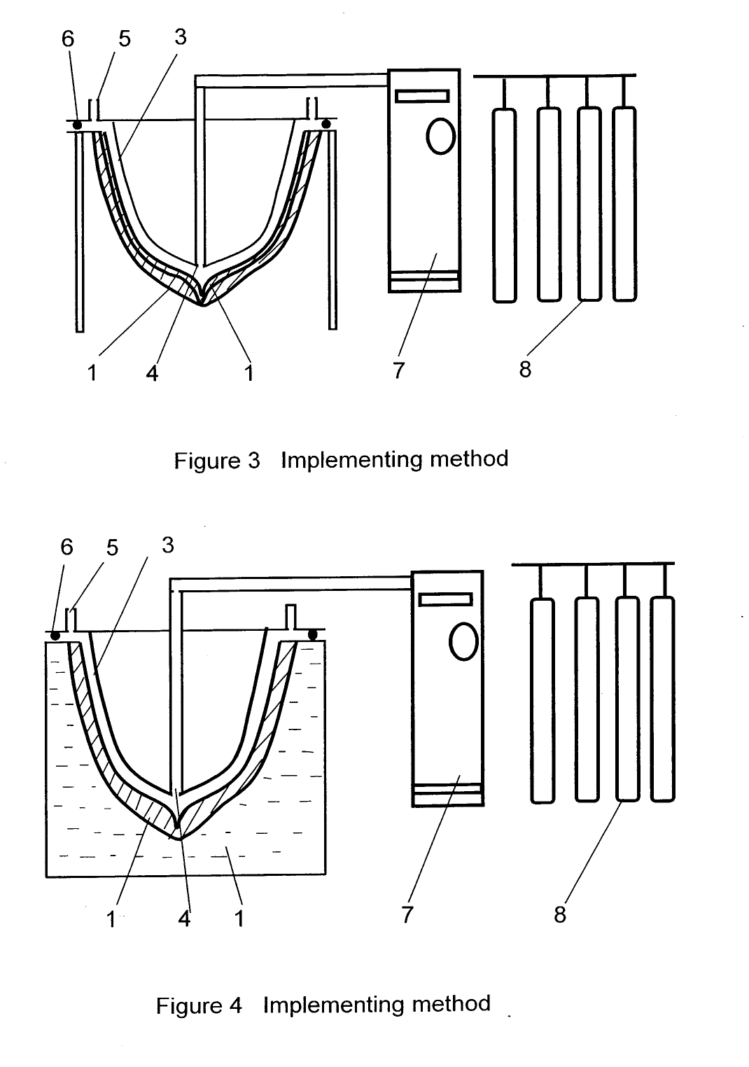

FIG. 3 shows the schematic diagram of a third preferred embodiment of this process. In this approach, a liquid coating is applied onto the surface of a mold 1, which is heated to 70° C. (158° F.) by means of heating cloth 13. The mold 1 shown here is the cross-section of boat mold. After the coating is applied on the surface of the mold, a mold cover 3 with inlets 4 and outlets 5 covers the entire mold surface. There is a seal 6 between the mold 1 and the mold cover 3 along the perimeter of the mold. The gap between the mold cover 3 and the surface of the mold 1 can vary from 2 mm to 100 mm or above. An inert gas such as, but not limited to, nitrogen gas, flows into the gap between the mold surface 1 and the mold cover 3 to displace the air. The purity of inert gas in the gap varies from 90% to 99.999%. The pressure in the gap is a little larger than the atmospheric pressure by 1 to 20%. The inert gas is supplied by either a gas generator 7 or compressed gas cylinders 8 with a purity of 95% to 99.999%. After a certain time, from 5 min to 2 hours, the mold cover 3 is removed, and the coating surface is ready to laminate. For example, glass fibers and a liquid resin can be applied onto the coating surface to produce a composite boat. The advantage of this approach is the uniform temperature on the surface of the mold.

FIG. 4 shows the schematic diagram of a fourth preferred embodiment of this process. In this approach, a liquid coating is applied onto the surface of a mold 1, which is heated to a proper temperature from room temperature to 70° C.(158° F.) by a hot liquid bath 14. The mold 1 shown here is the cross-section of boat mold. After the coating is applied on the surface of the mold, a mold cover 3 with inlets 4 and outlets 5 covers the entire mold surface. There is a seal 6 between the mold 1 and the mold cover 3 along the perimeter of mold. The gap between the mold cover 3 and the surface of the mold 1 can vary from 2 mm to 100 mm or above. An inert gas such as, but not limited to, nitrogen gas, flows into the gap between the mold surface 1 and the mold cover 3 to displace the air. The purity of inert gas in the gap varies from 90% to 99.999%. The pressure in the gap is a little larger than the atmospheric pressure by 1 to 20%. The inert gas is supplied by either a gas generator 7 or compressed gas cylinders 8 with a purity of 95% to 99.999%. After a certain time, from 5 min to 2 hours, the mold cover 3 is removed, and the coating surface is ready to laminate. For example, glass fibers and a liquid resin can be applied onto the coating surface to produce a composite boat.

Compared to the same coatings cured in atmospheric air, coatings cured by the inventive process have significantly shorter tacky times and exhibit improved physical properties, chemical resistance and weatherability.

Conventional gel coats are useful for providing desirable surface appearance (color, high gloss, smooth surface aspect) to reinforced composites. Additionally the gel coat serves to provide good resistance to weather (UV light, moisture) and to protect the composite mold during the fabrication of the composite laminate. During the fabrication of a gel coated composite laminate the gel coat is applied to a mold that has the inverse shape (relief) of the part to be built. The gel coat is allowed to reach a low tack or tack free state via curing and/or evaporation of volatile components in the gel coat. The low/non-tacky gel coat is then laminated with an open mold laminating resin, an SMC/BMC compound, or other common methods of applying a laminate to the gel coat such as resin transfer molding, vacuum bagging, infusion molding, etc. The laminate is allowed to cure and the part is then remove from the mold.

Current commercially available gel coats are produced by dispersing pigments, fillers, and additives into an unsaturated polyester resin solution. Styrene monomer and methyl methacrylate monomer are commonly used as reactive diluents to prepare the unsaturated polyester resin solution. The liquid gel coat is converted to a cured solid film by the addition of an organic initiator, commonly methyl ethyl ketone peroxide (MEKP). The gel coat film reaches a tack-free state in approximately one hour after the MEKP.

In the following examples, the terms “tackiness” and “wet” are used to qualify the surface stickiness. The term “tacky” is defined as transfer of gel coat to finger tip when touching the coating surface with light pressure, and “wet” is defined as liquid state on the coating surface. By contrast, a non-tacky gel coat surface does not produce a transfer of coating material to the finger when light pressure is applied to the coating surface on the opposite side of the mold.

### COMPARATIVE SAMPLE A

Comparative Sample A (C.S.A), a conventional white isophthalic gel coat designated 944W005 (available from Cook Composites & Polymers—820 E. 14^{th} Avenue N. Kansas City, Mo. 64116 (816) 391-6000) was tested to determine the evolution of film tackiness. The C.S.A gel coat contains only styrene and methyl methacrylate as solvents and reactive crosslinking monomers. The gel coat was spray applied to a waxed mold using a Binks 62 pressure pot spray gun. The gel coat was cured at 25° C. using 1.25% Lupersol™ DDM-9 MEKP initiator (Atofina—King of Prussia, Pa.). The tackiness of the C.S.A gel coat is shown in Table 1. As shown, C.S.A was tack free in 45 minutes at room temperature when exposed to air.

TABLE 1
C. S. A Conventional Gel Coat Tackiness versus Time

| Time (min) | Tackiness on coating surface |
|---|---|
| 5 | wet |
| 10 | wet |
| 30 | tacky |
| 45 | tack free |

Conventional gel coat do not fully cure at the surface exposed to air because of the well-known air-inhibited curing mechanism. Conventional gel coats achieve a tack-free state at the surface giving the appearance of cure. The tack-free state occurs when (a) the volatile crosslinking monomers (styrene, and methyl methacrylate (MMA)) evaporate at the surface and (b) the glass transition temperature of the remaining polymer is sufficiently high (typically greater that 10° C.). An ultra-low VOC gel coat usually contains the following composition: base resin, such as unsaturated polyester or vinyl ester, non-volatile monomers, such as mono-, di-, or tri-function acrylates; fillers, such as TiO₂, aluminum trihydrate, or clay; and, additives, such as wetting and dispersing additive, defoamer, and rheological additive. When liquid monomers that are essentially non-volatile at room temperature are substituted for styrene and methyl methacrylate in the resin solution the resulting gel coat remains wet or tacky indefinitely at the surface exposed to air due to air inhibition of cure.

### Ultra-low VOC Gel Coat

The same ultra-low VOC gel coat was used for Comparative Samples B, C and Examples 1-7. This ultra-low VOC gel coat was prepared using a high-speed disperser. The ultra-low VOC gel coat formulation was as follows:

| | | |
|---|---|---|
| Resin | 45% | Unsaturated isophthalic |
| | | polyester polymer - available from |
| | | Cook Composites and Polymers |
| Monomers | 44.8% | Tetraethylene glycol |
| | | diacrylate - available from Sartomer |
| Fillers | 10% | Titanium Dioxide Pigment - available from Dupont |
| Additives | 0.2% | Cobalt Octoate |
| | | Solution (6% active metal) - available from |

### COMPARATIVE SAMPLE B

For Comparative Sample B, the ultra-low VOC gel coat was applied as previously mentioned in C.S.A and evaluated for the evolution of surface tackiness. The ultra-low VOC gel coat was cured at 25° C. using 1.25% Lupersol™ DDM-9 MEKP initiator (Atofina—King of Prussia, Pa.). The tackiness of the C.S.B gel coat is shown in Table 2.

TABLE 2
C. S. B Tackiness versus Time

| Time (h) | Tackiness on coating surface |
|---|---|
| 1 | Wet |
| 5 | Wet |
| 10 | Wet |
| 30 | Wet |
| 50 | Wet |
| 100 | Wet |
| 500 | Wet |

The C.S.B gel coat remained wet after 500 hours. The wet gel coat was unusable for the purpose of constructing a gel coated composite laminate. The wet gel coat cannot be laminated with an open mold laminating resin, an SMC/BMC compound, or other common methods of applying a laminate to the gel coat such as resin transfer molding, vacuum bagging, infusion molding, etc.

The replacement of volatile monomers such as styrene and methyl methacrylate with liquid monomers that are non-volatile at room temperature produce gel coats that remain wet and therefore unusable.

### EXAMPLE 1

For Example 1 (Ex. 1), the ultra-low VOC gel coat was applied as previously mentioned in C.S.A and evaluated for the evolution of surface tackiness under an inert gas environment that was 99.99% nitrogen. The gel coat was cured at 25° C. using 1.25% Lupersol™ DDM-9 MEKP initiator (Atofina—King of Prussia, Pa.). The inert gas environment was achieved using nitrogen gas as depicted in implementing method 1 of FIG. 1. The oxygen level was measured by an oxygen meter (407510 from Extech Instrument). The tackiness of the Ex. 1 gel coat was recorded is shown in Table 3.

TABLE 3
Example 1 Tackiness versus Time

| Time (hour) | Tackiness on coating surface |
|---|---|
| 1 | wet |
| 5 | wet |
| 15 | wet |
| 20 | tacky |
| 30 | tack free |

The use of an inert gas environment alone at room temperature does not produce a styrene/MMA substituted gel coat that cures as rapidly as conventional gel coats which contain styrene/MMA as reactive diluents.

The gel coat did eventually achieve a tack free state after 30 hours at room temperature. Although an example of the current invention, Ex. 1 is less preferred due to the long cure time. This time is unacceptably long to satisfy practical commercial composite fabrication requirements for the following reasons.

(1) Commercial fabrication commonly requires that the composite mold on which the gel coat is applied be used to produce multiple composite parts per day (typical cycle time of 2-6 hours), and

(2) The cost of inert gas per part is excessive when the cure time is very long as in this example.

### EXAMPLE 2

For Example 2, the ultra-low VOC gel coat was applied as previously mentioned in C.S.A and evaluated for the evolution of surface tackiness. The Ex. 2 gel coat was cured at 48° C. in an environment of 99.99% nitrogen using 1.25% Lupersol™ DDM-9 MEKP initiator (Atofina—King of Prussia, Pa.). The inert gas environment was achieved using nitrogen gas as depicted in implementing method 1 of FIG. 1. The tackiness of the Ex. 2 gel coat is reported in Table 4.

TABLE 4
Example 2 Tackiness versus Time

| Time (min) | Tackiness on coating surface |
|---|---|
| 3 | wet |
| 5 | tacky |
| 7 | tacky |
| 9 | tack free |

The combination of elevated temperature and inert gas environment produces a gel coat which achieves a tack free state as fast or faster than conventional gel coats which contain styrene/MMA as reactive diluents.

### COMPARATIVE SAMPLE C

For Comparative Sample C, the ultra-low VOC gel coat was applied as previously mentioned in C.S.A and evaluated for the evolution of surface tackiness. The gel coat was cured at 48° C. temperature in an environment that is open to the atmosphere using 1.25% Lupersol™ DDM-9 MEKP initiator (Atofina—King of Prussia, Pa.). The oxygen concentration was measured as previously mentioned in Ex. 1. The tackiness of the C.S.C gel coat is reported in Table 5. These results show that increasing the cure temperature in a non-inert environment does not produce a tack free surface with ultra-low VOC.

TABLE 5
Comparative Sample C Tackiness versus Time

| Time (h) | Tackiness on coating surface |
|---|---|
| 1 | wet |
| 5 | wet |
| 7 | wet |
| 17 | wet |

### EXAMPLE 3

For Example 3, the ultra-low VOC gel coat was applied as previously mentioned in C.S.A and evaluated for the evolution of surface tackiness. The gel coat was cured at 53° C. temperature in an environment that is 99.99% nitrogen using 1.25% Lupersol™ DDM-9 MEKP initiator (Atofina—King of Prussia, Pa.). The oxygen concentration was measured as previously mentioned in Ex. 1. The inert gas environment was achieved using nitrogen gas as depicted in implementing method 1 of FIG. 1. The tackiness of the gel coat is reported in Table 6. Compared to Ex. 2, these results show further reduction in achieving a tack free state by increasing the cure temperature from 48° C. to 53° C.

TABLE 6
Example 3 Tackiness versus Time

| Time (min) | Tackiness on coating surface |
|---|---|
| 2 | wet |
| 3.6 | wet |
| 5 | wet |
| 7 | tack free |

### EXAMPLE 4

For example 4, the ultra-low VOC gel coat was applied as previously mentioned in C.S.A and evaluated for the evolution of surface tackiness. The gel coat was cured at 48° C. temperature in an environment that is 98.3% nitrogen using 1.25% Lupersol™ DDM-9 MEKP initiator (Atofina—King of Prussia, Pa.). The oxygen concentration was measured as previously mentioned in Ex. 1. The inert gas environment was achieved using nitrogen gas as depicted in implementing method of FIG. 1. The tackiness of the Ex. 4 gel coat is reported in Table 7.

TABLE 7
Example 5 Tackiness versus Time

| Time (min) | Tackiness on coating surface |
|---|---|
| 3 | wet |
| 5 | wet |
| 15 | tacky |
| 20 | tack free |

### EXAMPLE 5

For Example 5, the ultra-low VOC gel coat was applied as previously mentioned in C.S.A and evaluated for the evolution of surface tackiness. The gel coat was cured at 48° C. temperature in an environment that is 97. 1% nitrogen using 1.25% Lupersol™ DDM-9 MEKP initiator (Atofina —King of Prussia, Pa.). The oxygen concentration was measured as previously mentioned in Ex. 1. The inert gas environment was achieved using nitrogen gas as depicted in implementing method 1 of FIG. 1. The tackiness of the Ex. 5 gel coat is reported in Table 8.

TABLE 8
Example 5 Tackiness versus Time

| Time (min) | Tackiness on coating surface |
|---|---|
| 10 | wet |
| 23 | tacky |
| 30 | tacky |
| 36 | tack free |

### EXAMPLE 6

For Example 6, the ultra-low VOC gel coat was applied as previously mentioned in C.S.A and evaluated for the evolution of surface tackiness. The gel coat was cured at 48° C. temperature in an environment that is 94% nitrogen using 1.25% Lupersol™ DDM-9 MEKP initiator (Atofina—King of Prussia, Pa.). The oxygen concentration was measured as previously mentioned in Ex. 1. The inert gas environment was achieved using nitrogen gas as depicted in implementing method 1 of FIG. 1. The tackiness of the Ex. 6 gel coat is reported in Table 9.

TABLE 9
Example 6 Tackiness versus Time

| Time (min) | Tackiness on coating surface |
|---|---|
| 11 | wet |
| 23 | wet |
| 40 | wet |
| 59 | tacky |
| 70 | tacky |
| 74 | tack free |

Comparison of Examples 2, 4, 5 and 6 show that the concentration of oxygen has a profound effect on the rate of cure of the styrene/MMA substituted (i.e., ultra-low VOC) gel coat. The concentration of oxygen should be less than 10%, preferably less than 5%, and most preferably less than 3%.

### EXAMPLE 7

For Example 7, the ultra-low VOC gel coat was applied as previously mentioned in C.S.A and evaluated for the evolution of surface tackiness. The gel coat was cured at 48° C. temperature in an environment that is blanketed by carbon dioxide gas (99.5%) 25° C. using 1.25% Lupersol™ DDM-9 MEKP initiator (Atofina—King of Prussia, Pa.). The oxygen concentration was measured as previously mentioned in Ex. 1. The inert gas environment was achieved using a dry ice placed between the mold and the mold cover. The tackiness of the Ex. 7 gel coat is reported in Table 10.

TABLE 10
Example 7 Tackiness versus Time

| Time (min) | Tackiness on coating surface |
|---|---|
| 4.5 | wet |
| 6.5 | wet |
| 8.1 | wet |
| 9.1 | tacky |
| 10.1 | tacky |
| 12.1 | tack free |

The tack free time and inert gas purity for Ex. 7 is between the tack free times and inert gas purities of Ex. 2 and Ex. 4. This shows that different inert gases provide similar results.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

We claim:

1. An in-mold coating process comprising the steps of:
(a) providing a mold having at least one surface adapted to form a molded part;
(b) applying a curable coating to the surface of the mold, wherein the coating comprises a resin curable by a free-radical reaction and the free-radical curing reaction is inhibited by the presence of oxygen;
(c) contacting the applied curable coating with a gas inert to the coating thereby displacing or diluting atmospheric air in contact with the coating such that the oxygen content in the gas in contact with the applied coating is less than the oxygen content in air;
(d) curing the coating while the coating remains in contact with the inert gas.

2. The process of claim 1 wherein the amount of oxygen in the gas in contact with the coating in step (c) and step (d) is no more than about 10% by weight of the total gas.

3. The process of claim 1 wherein the amount of oxygen in the gas in contact with the coating in step (c) and step (d) is no more than about 5% by weight of the total gas.

4. The process of claim 1 wherein the amount of oxygen in the gas in contact with the coating in step (c) and step (d) is no more than about 3% by weight of the total gas.

5. The process of claim 1 the gas inert to the coating is selected from nitrogen, carbon dioxide and the noble gases.

6. The process of claim 1 further comprising the step of:
(e) positioning a mold cover in close proximity to or in contact with the mold to substantially enclose the coated surface thereby creating a contained space between the mold and the mold cover,
wherein step (e) occurs prior to or concurrently with step (c).

7. The process of claim 6 wherein the mold cover contacts the mold to form a gas tight seal with the mold.

8. The process of claim 6 wherein the contained space between the mold and the mold cover is between about 2 mm and about 100 mm across.

9. The process of claim 1 further comprising:
(f) heating the inert gas or mold or both to a temperature greater than room temperature,
wherein step (t) occurs prior to or concurrently with step (d).

10. The process of claim 9 wherein the inert gas or mold or both are heated to a temperature up to about 100° C.(212° F.).

11. The process of claim 9 wherein the inert gas or mold or both are heated to a temperature between 40-70° C.(104-158° F.).

12. The process of claim 1 wherein the curing coating has a shorter tacky time than the same coatings cured in atmospheric air.
